(19) United States
(12) Patent Application Publication
(10) Pub. No.: US 2026/0094285 A1
(43) Pub. Date: Apr. 2, 2026

(54) TRAJECTORY ESTIMATION AND ALIGNMENT USING OMNIDIRECTIONAL IMAGES / VIDEOS

(71) Applicant: FARO Technologies, Inc., Lake Mary, FL (US)

(72) Inventor: Jafar Amiri Parian, Schlieren (CH)

(21) Appl. No.: 19/395,408

(22) Filed: Nov. 20, 2025

Related U.S. Application Data
(63) Continuation of application No. PCT/US2024/033384, filed on Jun. 11, 2024.
(60) Provisional application No. 63/507,616, filed on Jun. 12, 2023.

(51) Int. Cl. G06T 7/246; G06T 7/33; G06T 7/73

(52) U.S. Cl. CPC G06T 7/248; G06T 7/337; G06T 7/74; G06T 2207/10016; G06T 2207/10028; G06T 2207/20076; G06T 2207/30241

(57) ABSTRACT

A system includes a camera to capture image data of an environment and to generate a series of trajectories. Each trajectory is generated based at least in part on a reliability threshold. The system further includes a processing system communicatively coupled to the camera, the processing system performing operations for aligning trajectories to a known layout. The operations include receiving, from the camera, the image data and the series of trajectories. The operations further include generating point clouds for each of the series of trajectories using the image data. The operations further include generating a layout for the environment based at least in part on the point clouds. The operations further include mapping the layout to the known layout and computing, during the mapping, mapping parameters. The operations further include, for each of the plurality of trajectories, aligning the trajectory to the known layout using the mapping parameters.

### CROSS-REFERENCE

This application is a continuation of PCT Application Serial No. PCT/US2024/033384, filed Jun. 11, 2024, the contents of which are incorporated by reference herein in their entirety, and this application claims the benefit of US Provisional Application Ser. No. 63/507,616 filed on Jun. 12, 2023, the contents of which are incorporated by reference herein in their entirety.

### BACKGROUND

The subject matter disclosed herein relates to images and/or videos with relatively large fields of view, such as panoramic images/videos, omnidirectional images/videos, fisheye images/videos, spherical images/videos, and/or the like including combinations and/or multiples thereof.

Spherical videos, also referred to as 360 degree videos, surround videos, or immersive videos, are video recordings that capture a substantially 360 degree view relative to a omnidirectional capturing device. Spherical images are similar 360 degree images that capture a substantially 360 degree view relative to a omnidirectional capturing device. For example, the omnidirectional capturing device can be a collection of individual cameras configured and arranged to capture a substantially 360 degree view. As another example, the omnidirectional capturing device can be an individual device known as an omnidirectional camera that is capable of capturing a substantially 360 degree view. In some cases, images can be stitched together to form spherical images. Similarly, videos can be stitched together to form spherical videos. For example, fisheye images/videos can be captured and stitched together to form spherical images/videos. Fisheye images are images that show a wide panoramic or hemispherical image and are generally captured with ultra-wide-angle lenses. Fisheye images/videos are considered omnidirectional for the purposes of the present disclosure.

Spherical images and/or spherical videos have various uses. For example, spherical images and/or spherical videos are useful for visualizing a project environment, such as a construction site. An omnidirectional capturing device can be moved throughout a construction site, for example, to capture spherical images and/or spherical video of the construction site, when can then be viewed to track progress against milestones, to evaluate quality, to document assets, and/or the like including combinations and/or multiples thereof. Spherical images and/or spherical videos can also be useful for immersive environments, such as virtual reality. For example, a spherical image and/or spherical video of an environment can be captured and used to generate a virtual reality environment and/or presented to a user to view. The spherical image and/or spherical video and/or the virtual reality environment generated using the spherical video can be displayed to a user via a display, multiple displays, a wearable head mounted display, and/or the like including combinations and/or multiples thereof. These and other use cases for spherical videos are possible.

Accordingly, while approaches to capturing spherical images and/or spherical videos are suitable for their intended purposes, what is needed is an approach to capturing spherical images and/or spherical videos having certain features of embodiments described herein.

### BRIEF DESCRIPTION

According to an embodiment, a system is provided. The system includes a camera to capture image data of an environment and to generate a series of trajectories. Each trajectory of the series of trajectories is generated based at least in part on a reliability threshold. The system further includes a processing system communicatively coupled to the camera, the processing system including a memory comprising computer readable instructions a processing device for executing the computer readable instructions. The computer readable instructions control the processing device to perform operations for aligning trajectories to a known layout. The operations include receiving, from the camera, the image data and the series of trajectories. The operations further include generating point clouds for each of the series of trajectories using the image data. The operations further include generating a layout for the environment based at least in part on the point clouds. The operations further include mapping the layout to the known layout. The operations further include computing, during the mapping, mapping parameters. The operations further include, for each of the plurality of trajectories, aligning the trajectory to the known layout using the mapping parameters.

According to another embodiment, a computer-implemented method generating a series of trajectories is provided. The method includes initiating capturing image data by a camera. The method further includes generating a first trajectory of the series of trajectories based at least in part on the image data. The method further includes determining, based on results of a reliability check, whether a reliability threshold is satisfied for the first trajectory. The method further includes, responsive to determining that the reliability threshold is not satisfied, building a second trajectory of the series of trajectories based at least in part on the image data.

According to another embodiment, a computer-implemented method for processing a series of trajectories is provided. The method includes generating a layout for an environment based at least in part on a collection of point clouds, each of the collection of point clouds corresponding to a trajectory of a plurality of trajectories. The method further includes mapping the layout to a known layout. The method further includes computing, during the mapping, mapping parameters. The method further includes, for each of the plurality of trajectories, aligning the trajectory to the known layout using the mapping parameters.

The above features and advantages, and other features and advantages, of the disclosure are readily apparent from the following detailed description when taken in connection with the accompanying drawings.

### BRIEF DESCRIPTION OF DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1A is a schematic image of a three-dimensional measurement device having a camera in accordance with an embodiment;

FIG. 1B is a schematic view of an omnidirectional camera for use with the three-dimensional measurement device of FIG. 1A in accordance with an embodiment;

FIG. 1C is a schematic view of an omnidirectional camera system with a dual camera for use with the three-dimensional measurement device of FIG. 1A;

FIG. 1D and FIG. 1E are images acquired by the dual camera of FIG. 1C;

FIG. 1D′ and FIG. 1E′ are images of the dual camera of FIG. 1C where each of the images has a field of view greater than 180 degrees;

FIG. 1F is a merged image formed from the images of FIG. 1D and FIG. 1E in accordance with an embodiment;

FIG. 2 is a schematic illustration of a processing system for trajectory estimation and alignment using omnidirectional images and/or omnidirectional videos according to one or more embodiments described herein;

FIGS. 3A and 3B together are a flow diagram of a method for trajectory estimation and alignment using omnidirectional images and/or omnidirectional videos according to one or more embodiments described herein; and

FIG. 4 is a schematic illustration of a processing system for implementing the presently described techniques according to one or more embodiments described herein.

The detailed description explains embodiments of the disclosure, together with advantages and features, by way of example with reference to the drawings.

### DETAILED DESCRIPTION

Embodiments described herein provide for trajectory estimation and alignment using omnidirectional images and/or omnidirectional videos. A series of omnidirectional images and/or an omnidirectional video can be captured using an omnidirectional capturing device (e.g., a collection of individual cameras configured and arranged to capture a substantially 360 degree view, an individual device known as an omnidirectional camera that is capable of capturing a substantially 360 degree view, and/or the like including combinations and/or multiples thereof). For example, a user can hold the omnidirectional capturing device and walk through an environment with the omnidirectional capturing device to capture a series of images and/or a video of the environment. In other examples, the omnidirectional capturing device can be mounted to a device (e.g., a vehicle, a mobile tripod, and/or the like including combinations and/or multiples thereof), which is then moved through the environment to capture the video of the environment. According to one or more embodiments described herein, a video trajectory is computed for the movement of the omnidirectional capturing device using the sequence of images and/or the video and the trajectory can be overlaid on an existing representation of the environment (e.g., a 2D map, such as a floorplan or blueprint).

Such approaches to capturing sequences of omnidirectional images and/or omnidirectional videos are natural to users, low cost, and can be used for various reasons (e.g., to visualize an environment, to track progress against milestones, to evaluate quality, to document assets, and/or the like including combinations and/or multiples thereof).

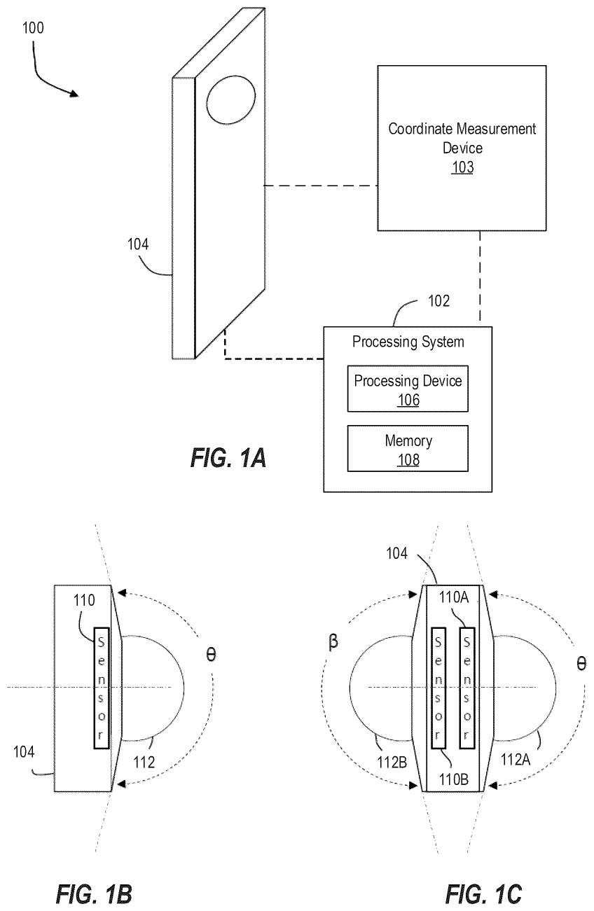

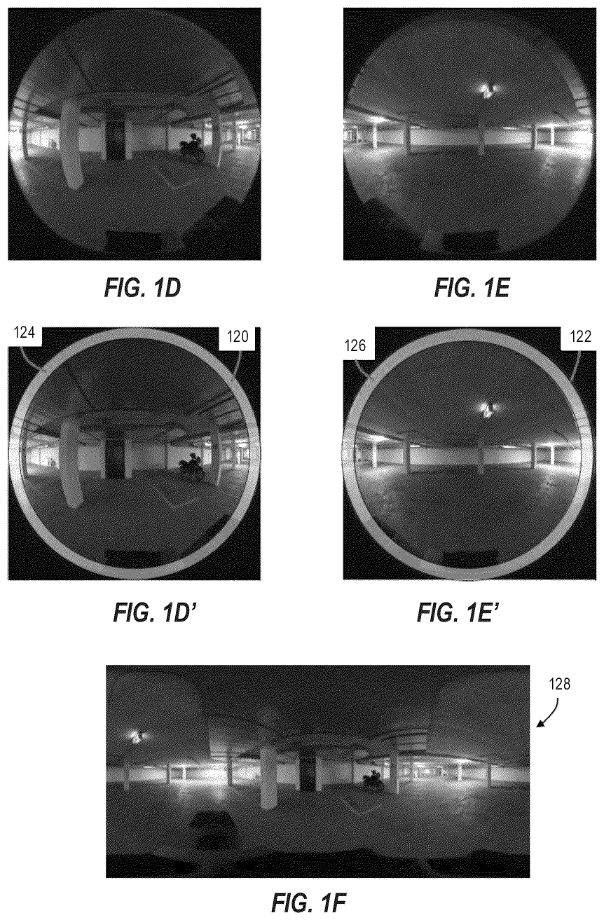

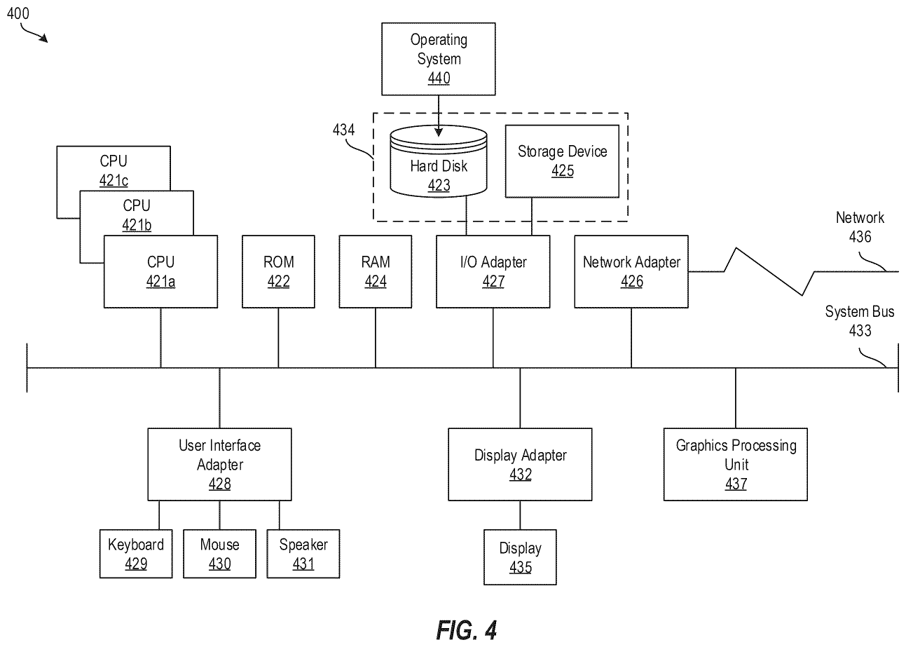

An example of a system for capturing sequences of omnidirectional images and/or omnidirectional videos is now described referring to FIGS. 1A, 1B, 1C. These figures show an embodiment of an image acquisition system 100 for capturing data about an environment. For example, the image acquisition system 100 can capture omnidirectional images about an environment and can use the omnidirectional images to determine coordinates, such as three-dimensional coordinates, in the environment. As another example, the image acquisition system 100 can capture omnidirectional videos of an environment. According to one or more embodiments described herein, the image acquisition system 100 includes a processing system 102 having an camera 104 associated therewith. According to one or more embodiments described herein, the camera 104 is an ultra-wide angle camera. In an embodiment, the processing system 102 can be communicatively coupled to the camera 104. In another embodiment, the processing system 102 and the camera 104 can be integrated into a single physical device (e.g., integrated into a common housing). The processing system 102 includes a processing device 106 (which can be one or more processors (e.g., the processing device(s) 421 of FIG. 4) and a system memory 108 (which can be one or more memories (e.g., the random access memory 424 and/or the read only memory 422 of FIG. 4). As discussed in more detail herein, the processing system 102 is configured to process and/or store data captured by the camera 104, such as omnidirectional videos.

According to one or more embodiments described herein, the image acquisition system 100 can also include a coordinate measurement device 103, which can be in communication, via a wired and/or wireless link, to one or both of the processing system 102 and/or the camera 104. The coordinate measurement device 103 is a metrology device that measures three-dimensional (3D) coordinates of an environment. For example, the coordinate measurement device 103 can use an optical process for acquiring coordinates of surfaces. Metrology devices of this category include, but are not limited to time-of-flight (TOF) laser scanners, laser trackers, laser line probes, photogrammetry devices, triangulation scanners, structured light scanners, or systems that use a combination of the foregoing. Examples of such metrology devices are described and shown in co-owned U.S. Patent Publication No. 2022/0137225 entitled “THREE DIMENSIONAL MEASUREMENT DEVICE HAVING A CAMERA WITH A FISHEYE LENS” which is incorporated by reference herein in its entirety.

In an embodiment, the camera 104 is an ultra-wide angle camera that includes a sensor 110 (FIG. 1B), that includes an array of photosensitive pixels. The sensor 110 is arranged to receive light from a lens 112. In the illustrated embodiment, the lens 112 is an ultra-wide angle lens that provides (in combination with the sensor 110) a field of view θ between substantially 100 and substantially 270 degrees. In an embodiment, the field of view θ is greater than substantially 180 degrees and less than substantially 270 degrees about an optical axis. It should be appreciated that while embodiments herein describe the lens 112 as a single lens, this is for examplary purposes and the lens 112 includes a plurality of optical elements in other embodiments. It should be further appreciated that in other embodiments, the field of view is greater than 63 degrees, less than 180 degrees, or between 63 degrees and 180 degrees for example.

In an embodiment, the camera 104 includes a pair of sensors 110A, 110B that are arranged to receive light from ultra-wide angle lenses 112A, 112B respectively (FIG. 1C). The sensor 110A and lens 112A are arranged to acquire images in a first direction and the sensor 110B and lens 112B are arranged to acquire images in a second direction. In the illustrated embodiment, the second direction is opposite the first direction (e.g. substantially 180 degrees apart). A camera having opposingly arranged sensors and lenses with at least substantially 180 degree field of view are sometimes referred to as an omnidirectional camera, 360 degree camera, or a panoramic camera as it acquires an image in a substantially 360 degree volume about the camera. It should further be appreciated that while embodiments herein refer to a “camera,” any suitable image acquisition device having a wide angle field of view (e.g., greater than 63 degrees) may be used without deviating from the teachings provided herein.

It should be appreciated that when the field of view is greater than substantially 180 degrees, there will be an overlap 120, 122 between the acquired images 124, 126 as shown in FIG. 1D′ and FIG. 1E′. In some embodiments, the images are combined to form a single image 128 of at least a substantial portion of the spherical volume about the camera 104 as shown in FIG. 1F.

It should be appreciated that, as sequences of omnidirectional images and/or omnidirectional videos are captured (e.g., by the camera 104), such images (which are frames of spherical videos) are stitched together to form spherical images, for example, which are generally geometrically inaccurate due to the nature of the lenses used in the capturing devices. Moreover, the capturing device (e.g., the camera 104) passes through areas of an environment where it is dark or where few visual features exist. For example, an indoor hallway with few doors or other features causes drift to occur for tracking the capturing device. As another example, an outdoor area where buildings are similar (e.g., apartments, townhomes, row houses, etc.) causes drift to occur for tracking the capturing device because the features are difficult to distinguish from one another. It is difficult to perform tracking in such places (e.g., dark portions of an environment or where few visual features exist). Tracking refers to detecting the pose of the capturing device during tracking where the pose refers position and orientation of the capturing device. The position is a point in space of the capturing device denoted by three coordinates (x, y, z), which are local coordinates for a local coordinate system or world coordinates for a world coordinate system in various instances. The orientation refers to how the device is oriented at the position relative to the environment and can be expressed in terms of pitch, roll, and yaw, for example.

Tracking or position estimation can be inaccurate due to the conditions (e.g., lighting conditions, insufficient features) of the environment. This inaccuracy is often observed as a drift, which is a deviation at some point in trajectory and is accumulated over time. For example, in a long hallway with few features, the trajectory will slowly curve due to the accumulated errors even though the hallway is straight. Currently, there are no known solutions for these situations, namely trajectory loss or drift, especially those caused by insufficient features.

A trajectory is an imaginary line through the perspective center (including the angle of the sensor) along the path traveled for the capturing device (e.g., an omnidirectional capturing device, such as the camera 104). It should be appreciated that while embodiments herein refer to a trajectory along a straight line, this is for examplary purposes and the claims should not be so limited. In other embodiments, the trajectory extends along a line that is comprised or a plurality of straight line segments, a continuous or segmented curved line, or a combination of the foregoing.

One or more embodiments described herein provide for trajectory estimation using omnidirectional images and/or omnidirectional videos captured by an omnidirectional capturing device, such as the camera 104. Additionally or alternatively, one or more embodiments described herein provide for aligning a computed layout of an environment generated using a sequence of omnidirectional images and/or an omnidirectional video to a layout, map, or model of the environment. Examples of layouts, maps, or models of the environment include floor plans, blueprints, computer-aided design (CAD) models, building information modeling (BIM) models, and/or the like including combinations and/or multiples thereof.

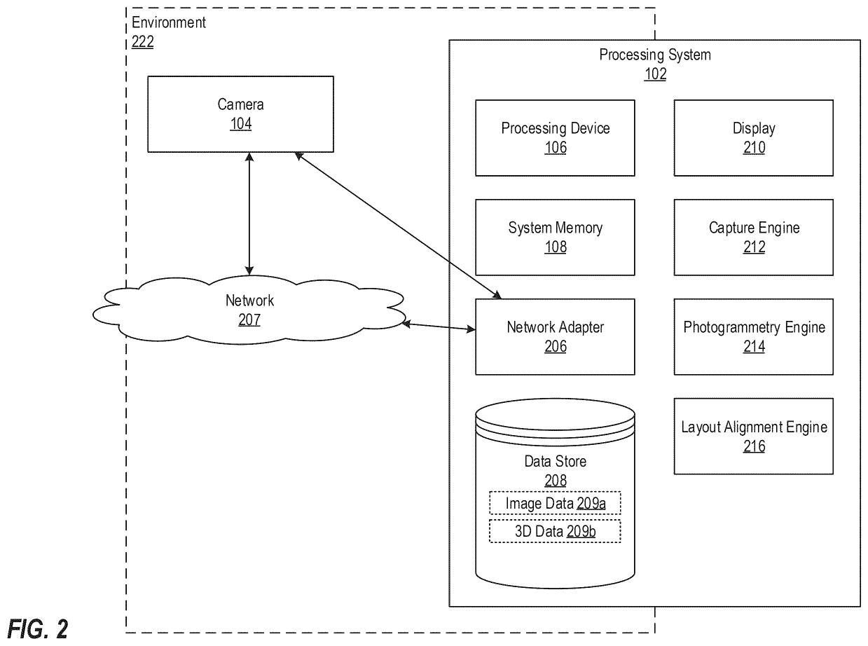

Turning now to FIG. 2, the processing system 102 and the camera 104 (e.g., an omnidirectional capturing device) of FIG. 1A are shown in more detail according to one or more embodiments described herein. In particular, FIG. 2 shows the processing system 102 for trajectory estimation and alignment using omnidirectional images and/or omnidirectional videos according to one or more embodiments described herein.

The processing system 102 can be any suitable computing device, such as a laptop computer, a desktop computer, a smartphone, a tablet computer, and/or the like, including combinations and/or multiples thereof. FIG. 4 depicts the processing system 102 in more detail. As shown in FIG. 2, the processing system 102 includes a processing device 106 (e.g., one or more of the processing devices 421 of FIG. 4), a system memory 108 (e.g., the RAM 424 and/or the ROM 422 of FIG. 13), a network adapter 206 (e.g., the network adapter 426 of FIG. 4), a data store 208, a display 210, a capture engine 212, a photogrammetry engine 214, and a layout alignment engine 216.

The various components, modules, engines, etc. described regarding FIG. 2 (e.g., the capture engine 212, the photogrammetry engine 214, and the layout alignment engine 216) can be implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the engine(s) described herein can be a combination of hardware and programming. The programming can be processor executable instructions stored on a tangible memory, and the hardware can include the processing device 106 for executing those instructions. Thus, the system memory 108 can store program instructions that when executed by the processing device 106 implement the engines described herein. Other engines can also be utilized to include other features and functionality described in other examples herein.

The network adapter 206 enables the processing system 102 to transmit data to and/or receive data from other sources, such as the camera 104. For example, the processing system 102 receives image data (e.g., omnidirectional images and/or omnidirectional video of the environment 222) from the camera 104 directly and/or via the network 207. The image data (e.g., the omnidirectional images and/or the omnidirectional video) from the camera 104 can be stored in the data store 208 of the processing system 102 as image data 209a, which is displayed on the display 210.

The network 207 represents any one or a combination of different types of suitable communications networks such as, for example, cable networks, public networks (e.g., the Internet), private networks, wireless networks, cellular networks, or any other suitable private and/or public networks. Further, the network 207 can have any suitable communication range associated therewith and include, for example, global networks (e.g., the Internet), metropolitan area networks (MANs), wide area networks (WANs), local area networks (LANs), or personal area networks (PANs). In addition, the network 207 includes any type of medium over which network traffic is carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof.

As the camera 104 (e.g., an omnidirectional image capturing device) moves through the environment 222 (e.g., an indoor environment, an outdoor environment, or a combination thereof), the camera 104 captures a sequence of omnidirectional images and/or an omnidirectional video of at least portions of the environment 222, where the images or video have a relatively wide field of view (e.g., fisheye images, panoramic images, omnidirectional images, and/or the like including combinations and/or multiples thereof). For example, the camera 104 can capture fisheye images, and the fisheye images can be stitched together to create a spherical image. The omnidirectional images, omnidirectional video, the spherical images, and/or the spherical video can be stored as image data 209a in the data store 208 or another suitable location (e.g., a node of a cloud computing environment). According to one or more embodiments described herein, the capture engine 212 can control the camera 104 and/or cause the camera 104 to capture the image data 209a (e.g., omnidirectional images and/or an omnidirectional video).

According to one or more embodiments described herein, the photogrammetry engine 214 can generate 3D data representative of at least portions of the environment 222 using the image data 209a. For example, the photogrammetry engine 214 can apply photogrammetry techniques to the image data 209a to generate 3D data and can store the resulting 3D data as 3D data 209a in the data store 208 or another suitable location (e.g., a node of a cloud computing environment). According to an embodiment, the photogrammetry engine 214 can simultaneously generate a trajectory and a sparse point cloud of the environment. According to another embodiment, the photogrammetry engine 214 can generate a dense point cloud of the environment once trajectory (partially or completely) is computed.

Photogrammetry is a technique for measuring objects using images, such as photographic images acquired by a digital camera (e.g., the camera 104) for example. Photogrammetry can make 3D measurements from 2D images or photographs, such as omnidirectional images, spherical images, frames of omnidirectional videos, and/or frames of spherical videos. When two or more images are acquired at different positions that have an overlapping field of view, common points or features are identified on each image. By projecting a ray from the camera location to the feature/point on an object on surface (e.g., a surface of the environment 222), the 3D coordinate of the feature/point are determineable using trigonometry or triangulation. In some examples, photogrammetry is based on markers/targets (e.g., lights or reflective stickers) or based on natural features. To perform photogrammetry, for example, images are captured, such as with a camera (e.g., the camera 104) having a sensor, such as a photosensitive array for example. By acquiring multiple images of the environment 222, or a portion of the environment 222, from different positions or orientations, 3D coordinates of points in the environment 222 is determined based on common features or points and information on the position and orientation of the camera 104 when each image was acquired. In order to obtain the desired information for determining 3D coordinates, features are identified in two or more images. Since the images are acquired from different positions or orientations, the common features are located in overlapping areas of the field of view of the images. It should be appreciated that photogrammetry techniques are described in commonly-owned U.S. patent application Ser. No. 17/379,268, the contents of which are incorporated by reference herein. With photogrammetry, two or more images are captured and used to determine 3D coordinates of features. The resulting 3D coordinates can be saved as 3D data 209b.

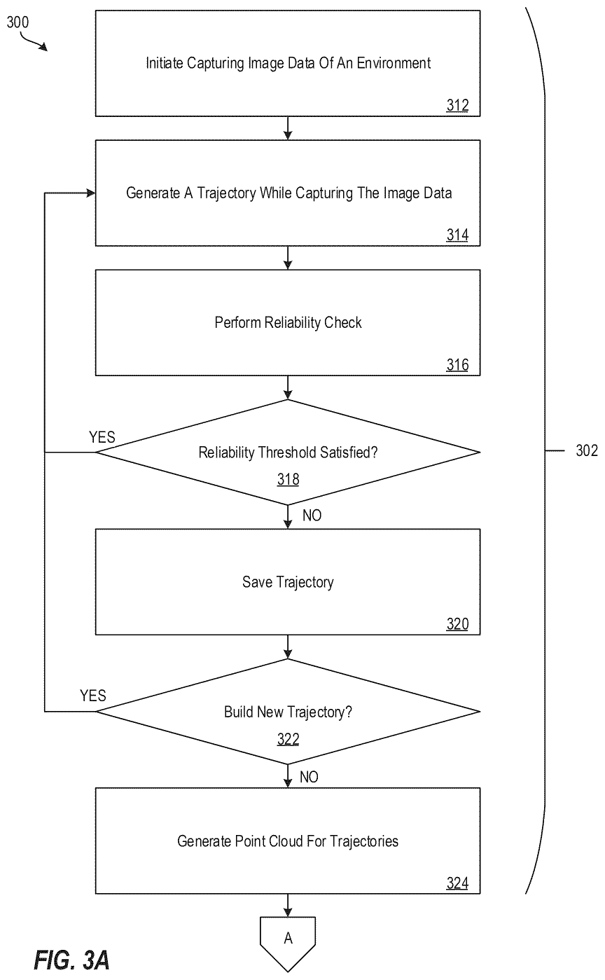

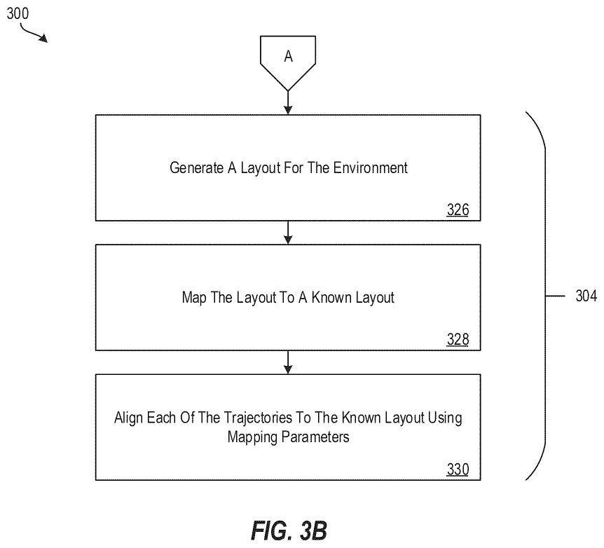

Further features of the capture engine 212, the photogrammetry engine 214, and/or the layout alignment engine 216 are now described in more detail with respect to FIGS. 3A and 3B.

Particularly, FIGS. 3A and 3B together depict a flow diagram of a method 300 for trajectory estimation and alignment using omnidirectional images and/or omnidirectional videos according to one or more embodiments described herein. The method 300 can be performed by any suitable system and/or device, such as the processing system 102 of FIGS. 1A and 2, the processing system 400 of FIG. 4, and/or the like including combinations and/or multiples thereof. The method 300 is now described with reference to FIGS. 1A and 2 but is not so limited. The method 300 includes a capturing phase 302 and a processing phase 304. According to one or more embodiments described herein, the capturing phase 302 and the processing phase 304 is performed substantially sequentially and/or at different times. According to one or more embodiments described herein, the capturing phase 302 and the processing phase 304 can be performed by the same system or device or by different systems or devices. For example, the processing system 102 can perform the capturing in conjunction with the camera 104, collectively as the image acquisition system 100. As another example, the image acquisition system 100 (e.g., the combination of the processing system 102 and the camera 104) can perform the capturing phase 302, and another system or device (e.g., the processing system 400 of FIG. 4, a cloud computing node of a cloud computing system, and/or the like including combinations and/or multiples thereof) can perform the processing phase 304.

With reference to FIG. 3A, the capturing phase 302 begins at block 312, where the camera 104 initiates capturing image data (e.g., omnidirectional images and/or omnidirectional videos). According to one or more embodiments described herein, the image data can include fisheye images and/or fisheye videos (e.g., frames from fisheye videos). In some cases, the fisheye images and/or fisheye videos can be stitched together to form spherical images and/or spherical videos. According to one or more embodiments described herein, the image data can include spherical images and/or spherical videos (e.g., frames from the spherical videos). According to an embodiment, during the capturing, the processing system 102 builds a series of trajectories as the camera 104 moves relative to the environment. For example, at block 314, the processing system 102 generates a trajectory while capturing the image data as the camera 104 moves through the environment and/or as the environment moves relative to the camera 104. According to another embodiment, the processing system 102 builds the trajectories after the capturing is completed. For example, once the capturing is completed, the image data is transferred from the camera 104 to the processing system 102, and the processing system 102 computes the trajectories. Thus, according to one or more embodiments described herein, the trajectories can be generated while capturing the image data or after the image data capture is completed. As described herein, a trajectory is an imaginary line (or series of lines) through the perspective center (including the angle of the sensor) along the path traveled for the capturing device (e.g., an omnidirectional capturing device, such as the camera 104). Trajectory construction provides for estimating the position and angular orientation of images in 3D space. Because the sequence of the image capture is known, the images can be connected in 3D space with a unique sequence. The order of adding images to compute the trajectory can be different depending on the method of trajectory reconstruction used. According to an embodiment, trajectory estimation includes computing the trajectory by adding images sequentially with the same order of image capture. However, other approaches to computing the trajectory can be implemented. For example, according to one or more embodiments described herein, the trajectory can be other than the path along which the capturing device traveled. That is, trajectory reconstruction can be expanded include generating to an optimal direction that is not necessarily the direction that sequence of image/video are captured. Each of the trajectories of the series of trajectories is generated until a reliability threshold is no longer satisfied. That is, the processing system 102 builds a trajectory during the capturing (block 314), and the processing system 102 performs a reliability check at block 316. At decision block 318, is determined whether the reliability threshold is satisfied. If the reliability check is satisfied (“YES” at decision block 318), the camera 314 continues to build the trajectory while capturing the image data at block 314.

The reliability check at block 316 can be performed using internal measures of the camera 104, such as a number of common features between or among images or generated in 3D space, the root mean squares of back projected errors (RMSE), and/or the like including combinations and/or multiples thereof. When the reliability threshold is no longer satisfied, the trajectory building ends, and the processing system 102 can start building a new trajectory. The computed trajectory is stored for later post-processing (320). Non-limiting examples of reliability thresholds including a drift threshold (e.g., an amount of drift), an error threshold (e.g., an amount of error), and/or the like including combinations and/or multiples thereof.

If the reliability check is satisfied (“YES” at decision block 318), the processing system 102 continues to build the trajectory while capturing the image data at block 314. If the reliability check is not satisfied (e.g., the reliability threshold is exceeded) (“NO at decision block 318), the processing system 102 stops building the current trajectory. That is, once the reliability threshold is no longer satisfied (e.g., the amount of drift exceeds the drift threshold, the amount of error exceeds the error threshold), the trajectory building ends and a new trajectory can be built. Specifically, at block 320, the trajectory is saved responsive to the reliability check (block 316) indicating that the reliability threshold is not satisfied (decision block 318). No more image data (e.g., omnidirectional images and/or omnidirectional video) is added to the trajectory once the reliability threshold is exceeded according to one or more embodiments described herein. At decision block 322, it is determined whether to build a new trajectory from the same data set (e.g., a next trajectory in the series of trajectories). If so (“YES” at decision block 322), the method 300 returns to block 314 and proceeds to generate a new trajectory while capturing the image data.

If no new trajectory is desired (“NO” at decision block 322), the method 300 proceeds to block 324 where a point cloud for each of the trajectories is generated. For example, the camera 104 or another suitable device (e.g., the processing system 102) generates a dense point cloud for each of the trajectories using the image data (e.g., omnidirectional images, omnidirectional video, and/or the like including combinations and/or multiples thereof). The sparse point cloud of each trajectory has been already computed together with the corresponding trajectory reconstruction. According to one or more embodiments described herein, photogrammetry can be used to generate the dense point cloud as described herein. For example, the photogrammetry engine 214 can be used to generate dense point clouds for the trajectories using photogrammetry.

Once the point clouds are generated at block 324, the capturing phase 302 concludes, and the method 300 proceeds to the processing phase 304 (see FIG. 3B).

Turning now to FIG. 3B, the method 300 begins the processing phase 304 at block 326. Particularly, using the layout alignment engine 216, the processing system 102 uses the point cloud(s) generated for each of the trajectories at block 324 to generate a layout of the environment. The layout can be a 2D layout, a 3D layout, and/or the like including combinations and/or multiples thereof. The 2D or 3D layout can be computed through deep learning based techniques, for example. Examples of such deep learning based techniques include are described in the following references: “Learning Indoor Layouts from Simple Point-Clouds” by Mahmood et al.; “3D vision: point-cloud based room segmentation algorithm for accurate indoor odometry” by Brun et al.; “Floorplan generation from 3D point clouds: A space partitioning approach” by Fang et al.; and “Generation of Approximate 2D and 3D Floor Plans from 3D Point Clouds” by Stojanovic et al. Other possible deep learning based techniques are also possible.

At block 328, using the layout alignment engine 216, the processing system 102 maps the layout from block 326 to a known (or given) layout. For example, the known (or given) layout can be a floor plan, a blueprint, CAD model, a BIM model, and/or the like including combinations and/or multiples thereof. The layout alignment engine 216 generates mapping parameters, which includes scale, rotation matrix, translation, and/or the like including combinations and/or multiples thereof. According to one or more embodiments described herein, the known layout can be a known map that is a picture. The picture can be converted to a vectorized map (e.g., a CAD model). As an example, the vectorized map is an architectural floor plan, map from a mapping service (e.g., GOOGLE® maps), created from a 3D point cloud (e.g., using 3D mobile mapping), and/or the like including combinations and/or multiples thereof. The mapping at block 328 will also perform CAD model to CAD model mapping using registration techniques, such as Iterative Closest Point (ICP) following FAST Point Feature Histogram as described in “CAD-based Pose Estimation—Algorithm Investigation” by Annette Lef.

At block 330, using the layout alignment engine 216, the processing system 102 aligns the trajectories to the known layout using the mapping parameters from block 328. For example, the mapping parameters are used modify the trajectories to align with the known layout. As a result, many or most of the frames of image data are aligned to the known layout with minimal drift and increased accuracy. The processing phase 304 then ends.

Additional processes are also included, and it should be understood that the process depicted in FIGS. 3A and 3B represents an illustration, and that other processes may be added or existing processes may be removed, modified, or rearranged without departing from the scope of the present disclosure.

According to one or more embodiments described herein, the method 300 can be implemented using an omnidirectional camera and a processing system that supports light detection and ranging (LIDAR).

According to one or more embodiments described herein, the method 300 supports the use of 2D images, such as frame images captured by a camera of a smartphone. An angle of the camera can be used to provide perspective, for example. According to one or more embodiments described herein, spatial information from spatial images and/or spatial video can be added to 2D images (like orientation and position) and then can be connected to other existing data to form four-dimensional (4D) (time in addition to space).

It is understood that one or more embodiments described herein is capable of being implemented in conjunction with any other type of computing environment now known or later developed. For example, FIG. 4 depicts a block diagram of a processing system 400 for implementing the techniques described herein. In accordance with one or more embodiments described herein, the processing system 400 is an example of a cloud computing node of a cloud computing environment. In examples, processing system 400 has one or more central processing units (“processors” or “processing resources” or “processing devices”) 421a, 421b, 421c, etc. (collectively or generically referred to as processor(s) 421 and/or as processing device(s)). In aspects of the present disclosure, each processor 421 can include a reduced instruction set computer (RISC) microprocessor. Processors 421 are coupled to system memory (e.g., random access memory (RAM) 424) and various other components via a system bus 433. Read only memory (ROM) 422 is coupled to system bus 433 and includes a basic input/output system (BIOS), which controls certain basic functions of processing system 400.

Further depicted are an input/output (I/O) adapter 427 and a network adapter 426 coupled to system bus 433. I/O adapter 427 is a small computer system interface (SCSI) adapter that communicates with a hard disk 423 and/or a storage device 425 or any other similar component. I/O adapter 427, hard disk 423, and storage device 425 are collectively referred to herein as mass storage 434. Operating system 440 for execution on processing system 400 is stored in mass storage 434. The network adapter 426 interconnects system bus 433 with an outside network 436 enabling processing system 400 to communicate with other such systems.

A display (e.g., a display monitor) 435 is connected to system bus 433 by display adapter 432, which includes a graphics adapter to improve the performance of graphics intensive applications and a video controller. In one aspect of the present disclosure, adapters 426, 427, and/or 432 connected to one or more I/O busses that are in turn connected to system bus 433 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 433 via user interface adapter 428 and display adapter 432. A keyboard 429, mouse 430, and speaker 431 e are interconnected to system bus 433 via user interface adapter 428, which includes, for example, a Super I/O chip integrating multiple device adapters into a single integrated circuit.

In some aspects of the present disclosure, processing system 400 includes a graphics processing unit 437. Graphics processing unit 437 is a specialized electronic circuit designed to manipulate and alter memory to accelerate the creation of images in a frame buffer intended for output to a display. In general, graphics processing unit 437 is very efficient at manipulating computer graphics and image processing, and has a highly parallel structure that makes it more effective than general-purpose CPUs for algorithms where processing of large blocks of data is done in parallel.

Thus, as configured herein, processing system 400 includes processing capability in the form of processors 421, storage capability including system memory (e.g., RAM 424), and mass storage 434, input means such as keyboard 424 and mouse 430, and output capability including speaker 431 and display 435. In some aspects of the present disclosure, a portion of system memory (e.g., RAM 424) and mass storage 434 collectively store the operating system 440 to coordinate the functions of the various components shown in processing system 400.

In addition to one or more of the features described herein, or as an alternative, further embodiments of the system include that the image data comprises video selected from a group consisting of spherical video and fisheye video.

In addition to one or more of the features described herein, or as an alternative, further embodiments of the system include that the image data comprises video selected from a group consisting of spherical images and fisheye images.

In addition to one or more of the features described herein, or as an alternative, further embodiments of the system include that camera is a panoramic camera.

In addition to one or more of the features described herein, or as an alternative, further embodiments of the system include that the camera is an omnidirectional camera, wherein the omnidirectional camera has a substantially 360-degree field of view.

In addition to one or more of the features described herein, or as an alternative, further embodiments of the system include that generating the point clouds is performed using photogrammetry.

In addition to one or more of the features described herein, or as an alternative, further embodiments of the system include that a first trajectory of the series of trajectories is generated until the reliability threshold is exceeded.

In addition to one or more of the features described herein, or as an alternative, further embodiments of the system include that the reliability threshold is determined to be exceeded by performing a reliability check.

In addition to one or more of the features described herein, or as an alternative, further embodiments of the system include that the reliability check is based at least in part on a number of common features between two or more images.

In addition to one or more of the features described herein, or as an alternative, further embodiments of the system include that the reliability check is based at least in part on a root mean squares of back projected errors.

In addition to one or more of the features described herein, or as an alternative, further embodiments of the computer-implemented method include performing the reality check prior to determining whether the reliability threshold is satisfied for the first trajectory.

In addition to one or more of the features described herein, or as an alternative, further embodiments of the computer-implemented method include that the reliability check is based at least in part on a number of common features between two or more images.

In addition to one or more of the features described herein, or as an alternative, further embodiments of the computer-implemented method include that the reliability check is based at least in part on a root mean squares of back projected errors.

In addition to one or more of the features described herein, or as an alternative, further embodiments of the computer-implemented method include: generating a first point cloud for the first trajectory; and generating a second point cloud for the second trajectory.

In addition to one or more of the features described herein, or as an alternative, further embodiments of the computer-implemented method include that the first point cloud and the second point is generated using photogrammetry.

In addition to one or more of the features described herein, or as an alternative, further embodiments of the computer-implemented method include that the image data is selected form a group consisting of fisheye images, fisheye video, spherical images, and spherical video.

In addition to one or more of the features described herein, or as an alternative, further embodiments of the computer-implemented method include that the plurality of trajectories are generated while capturing image data.

In addition to one or more of the features described herein, or as an alternative, further embodiments of the computer-implemented method include that each of the collection of point clouds is generated using the image data.

It will be appreciated that one or more embodiments described herein will be embodied as a system, method, or computer program product and will take the form of a hardware embodiment, a software embodiment (including firmware, resident software, micro-code, etc.), or a combination thereof. Furthermore, one or more embodiments described herein take the form of a computer program product embodied in one or more computer readable medium(s) having computer readable program code embodied thereon.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) include only some of the described exemplary aspects. Accordingly, the disclosure is not to be seen as limited by the foregoing description, but is only limited by the scope of the appended claims.

What is claimed is:

1. A system comprising:
a camera to capture image data of an environment and to generate a series of trajectories, wherein each trajectory of the series of trajectories is generated based at least in part on performing a reliability check and determining that a reliability threshold is exceeded by a reliability metric comprising at least one root mean square of at least one back projected error associated with the trajectory, such that the generating of the trajectory ends and the trajectory is saved responsive to the at least one root mean square of the at least one back projected error associated with the trajectory exceeding the reliability threshold; and
a processing system communicatively coupled to the camera, the processing system comprising:
a memory comprising computer readable instructions; and
a processing device for executing the computer readable instructions, the computer readable instructions controlling the processing device to perform operations for aligning trajectories to a known layout, the operations comprising:
receiving, from the camera, the image data and the series of trajectories;
generating point clouds for each of the series of trajectories using the image data;
generating a layout for the environment based at least in part on the point clouds;
mapping the layout to the known layout;
computing, during the mapping, mapping parameters; and
for each of the plurality of trajectories, aligning the trajectory to the known layout using the mapping parameters.

2. The system of claim 1, wherein the image data comprises video selected from a group consisting of spherical video and fisheye video.

3. The system of claim 1, wherein the image data comprises video selected from a group consisting of spherical images and fisheye images.

4. The system of claim 1, wherein camera is a panoramic camera.

5. The system of claim 1, wherein the camera is an omnidirectional camera, wherein the omnidirectional camera has a substantially 360-degree field of view.

6. The system of claim 1, wherein generating the point clouds is performed using photogrammetry.

7. The system of claim 1, wherein a first trajectory of the series of trajectories is generated until the reliability threshold is exceeded.

8. The system of claim 1, wherein performing the reliability check comprises determining that an amount of drift associated with the trajectory exceeds a drift threshold, and generating of the trajectory ends and the trajectory is saved responsive to the amount of drift associated with the trajectory exceeding the drift threshold.

9. The system of claim 1, wherein the reliability check is based at least in part on a number of common features between two or more images.

10. The system of claim 1, wherein the reliability check is based at least in part on root mean squares of back projected errors determined for each of the trajectories.

11. A computer-implemented method for generating a series of trajectories, the method comprising:
initiating capturing image data by a camera;
generating a first trajectory of the series of trajectories based at least in part on the image data;
determining, based on results of a reliability check, whether a reliability threshold is satisfied for the first trajectory; and
responsive to determining that the reliability threshold is not satisfied based on determining that the reliability threshold is exceeded by a reliability metric comprising at least one root mean square of at least one back projected error associated with the first trajectory, building a second trajectory of the series of trajectories based at least in part on the image data, ending the generating of the first trajectory, and saving the first trajectory.

12. The computer-implemented method of claim 11, further comprising performing the reality check prior to determining whether the reliability threshold is satisfied for the first trajectory.

13. The computer-implemented method of claim 11, wherein the reliability check is based at least in part on a number of common features between two or more images.

14. The computer-implemented method of claim 11, wherein the reliability check is based at least in part on root mean squares of back projected errors determined for the first trajectory and the second trajectory.

15. The computer-implemented method of claim 11, further comprising:
generating a first point cloud for the first trajectory; and
generating a second point cloud for the second trajectory.

16. The computer-implemented method of claim 15, wherein the first point cloud and the second point cloud are generated using photogrammetry.

17. The computer-implemented method of claim 11, wherein the image data is selected form a group consisting of fisheye images, fisheye video, spherical images, and spherical video.

18. A computer-implemented method for processing a series of trajectories, the method comprising:
generating a layout for an environment based at least in part on a collection of point clouds, each of the collection of point clouds corresponding to a trajectory of a plurality of trajectories;
mapping the layout to a known layout;
computing, during the mapping, mapping parameters; and
for each of the plurality of trajectories, aligning the trajectory to the known layout using the mapping parameters;
wherein each trajectory of the series of trajectories is generated based at least in part on performing a reliability check to determine that a reliability threshold is exceeded by a reliability metric comprising at least one root mean square of at least one back projected error associated with the trajectory, such that the generating of the trajectory ends and the trajectory is saved responsive to the at least one root mean square of the at least one back projected error associated with the trajectory exceeding the reliability threshold.

19. The computer-implemented method of claim 18, wherein the plurality of trajectories are generated while capturing image data.

20. The computer-implemented method of claim 19, wherein each of the collection of point clouds is generated using the image data.
